(19) United States
(12) Patent Application Publication
(10) Pub. No.: US 2026/0279762 A1
(43) Pub. Date: Sep. 17, 2026

(54) SECONDARY BATTERY ELECTRODE MATERIAL SHEET AND METHOD FOR PRODUCING SAME

(71) Applicant: AISIN CORPORATION, Kariya (JP)

(72) Inventors: Masanari Mitsui, Kariya-shi (JP); Yuya Ishida, Kariya-shi (JP)

(73) Assignee: AISIN CORPORATION, Kariya (JP)

(21) Appl. No.: 19/567,632

(22) Filed: Mar. 16, 2026

(30) Foreign Application Priority Data
Mar. 17, 2025 (JP) 2025-042523

(51) Int. Cl. H01M 4/04; H01M 4/583

(52) U.S. Cl. CPC H01M 4/0471; H01M 4/583

(57) ABSTRACT

A method for producing a secondary battery electrode material sheet includes irradiating a composite fiber sheet containing a carbon fiber, a resin fiber, and graphite with a laser to carbonize the resin fiber to obtain a secondary battery electrode material sheet containing a carbide, the carbon fiber, and the graphite. The composite fiber sheet is a long sheet having a first surface and a second surface opposite to the first surface. The composite fiber sheet is supplied from a first roll for unwinding, the first surface of the composite fiber sheet is continuously subjected to laser irradiation on a surface of a second roll, and thereafter the obtained long secondary battery electrode material sheet is wound by a third roll for winding. A heat retaining body is interposed between the second surface of the composite fiber sheet subjected to the laser irradiation and the surface of the second roll.

### CROSS REFERENCE TO RELATED APPLICATIONS

This application is based on and claims priority under 35 U.S.C. § 119 to Japanese Patent Application 2025-042523, filed on Mar. 17, 2025, the entire content of which is incorporated herein by reference.

### TECHNICAL FIELD

This disclosure relates to a secondary battery electrode material sheet for use in forming an electrode of a secondary battery, such as a fuel cell, and a method for producing the same.

### BACKGROUND DISCUSSION

A polymer electrolyte fuel cell (hereinafter, simply referred to as a “fuel cell”) widely used as a power source of an automobile or the like is formed by laminating a plurality of fuel cells with separators interposed therebetween, and in one unit cell, a cathode (+) side electrode and an anode (−) side electrode are disposed on both surfaces of a polymer electrolyte membrane that selectively permeates specific ions, thereby forming a membrane electrode assembly. The cathode (+) side electrode and the anode (−) side electrode are each formed by a catalyst layer made of an ion exchange resin and an electrically conductive material, such as carbon supporting a catalyst such as platinum, and a porous gas diffusion layer disposed outside each catalyst layer. The separators are disposed outside the gas diffusion layer constituting the membrane electrode assembly, and have a gas flow path for supplying a fuel gas (anode gas) or an oxidizing gas (cathode gas) and discharging a product gas and an excess gas, and the membrane electrode assembly is sandwiched between the separators.

In the fuel cell having the above configuration, the gas diffusion layer constituting the electrode of the single cell battery is disposed to enhance diffusivity of a reaction gas. Since the gas diffusion layer has an action (gas diffusivity) of diffusing the fuel gas or the oxidizing gas supplied from the gas flow path in the separator to the catalyst layer adjacent to the gas diffusion layer, the gas diffusion layer has not only gas permeability but also electrical conductivity as a current collecting function of efficiently moving electrons for an electrochemical reaction. In addition, the gas diffusion layer always keeps the polymer electrolyte membrane and the catalyst layer in an optimum wet state, and in particular, in the gas diffusion layer of the cathode, in order to prevent a flooding phenomenon (a phenomenon in which pores of the gas diffusion layer are clogged with water) and stabilize power generation performance, water repellency (drainage property) for discharging excessive reaction product water or dew condensation water generated by an electrochemical reaction between hydrogen and oxygen during power generation is required.

In the related art, as a base material for forming the gas diffusion layer, a base material containing a carbon fiber as an electrically conductive fiber and a method for producing the same are known.

For example, JP 2003-147640A (Reference 1) discloses a continuous heat treatment method for a porous carbon fiber sheet, in which a porous carbon fiber sheet precursor impregnated with a resin, cured, and continuously supplied is subjected to a pre-carbonization treatment in a pre-carbonization heat treatment apparatus, and then subjected to a carbonization treatment at a temperature of 800° C. or higher and 3,000° C. or lower in a carbonization heat treatment apparatus having a muffle structure in an inert atmosphere.

JP 2018-40099A (Reference 2) discloses a method for producing a carbon fiber sheet, in which a carbon fiber sheet precursor made of at least a carbon fiber or an organic fiber capable of being converted into the carbon fiber is continuously run in a high-temperature furnace having a maximum temperature of 1,500° C. to 3,000° C. to be subjected to a heat treatment, and a carbon fiber sheet is wound, the method including cleaning at least one surface of the carbon fiber sheet after passing through the high-temperature furnace, and then winding the carbon fiber sheet.

In addition, JP 2020-95892A (Reference 3) discloses a method for producing a porous carbon electrode base material obtained by continuously conveying a carbon fiber sheet precursor containing a carbon fiber or a carbon fiber precursor fiber in a heat treatment furnace at 400° C. to 2,700° C. to be subjected to a heat treatment, and winding the resultant, in which a traveling sheet precursor is bent in a height direction by a traveling plate provided in a pass line of the sheet precursor from after unwinding to before winding, meandering of the traveling sheet precursor is prevented by a pair of guide members provided on both sides of the pass line, and a winding tension of the carbon fiber sheet precursor traveling on the pass line is set to 1 N/m to 25 N/m.

In a method for producing a secondary battery electrode material sheet containing a carbide, a carbon fiber, and graphite by irradiating, with a laser, a composite fiber sheet containing a carbon fiber, a resin fiber, and graphite or a composite fiber sheet in which a carbon fiber, a resin fiber, and graphite are bound to an adhesive resin to carbonize a resin component (the resin fiber or the adhesive resin), the composite fiber sheet may have voids between a plurality of fibers contained therein or between the fiber and the graphite, and there is room for effective use of laser energy for carbonizing the resin component.

A need thus exists for a method for producing a secondary battery electrode material sheet which is not susceptible to the drawback mentioned above.

### SUMMARY

According to an aspect of this disclosure, there is provided a method for producing a secondary battery electrode material sheet, the method including:
irradiating a composite fiber sheet containing a carbon fiber, a resin fiber, and graphite with a laser to carbonize the resin fiber to obtain a secondary battery electrode material sheet containing a carbide, the carbon fiber, and the graphite, in which
the composite fiber sheet is a long sheet having a first surface and a second surface opposite to the first surface,
the composite fiber sheet is supplied from a first roll for unwinding, the first surface of the composite fiber sheet is continuously subjected to laser irradiation on a surface of a second roll, and thereafter the obtained long secondary battery electrode material sheet is wound by a third roll for winding, and
a heat retaining body is interposed between the second surface of the composite fiber sheet subjected to the laser irradiation and the surface of the second roll.

According to another aspect of this disclosure, there is provided a secondary battery electrode material sheet obtained by the method for producing a secondary battery electrode material sheet of the above aspect.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic diagram showing an example of a method for producing a secondary battery electrode material sheet disclosed here;

FIG. 2 is a schematic diagram showing another example of the method for producing the secondary battery electrode material sheet disclosed here;

FIG. 3 is a schematic diagram showing still another example of the method for producing the secondary battery electrode material sheet disclosed here;

FIG. 4 is a schematic diagram showing yet another example of the method for producing the secondary battery electrode material sheet disclosed here; and

FIG. 5 is a schematic cross-sectional view showing an example of a secondary battery electrode material sheet produced by this disclosure.

### DETAILED DESCRIPTION

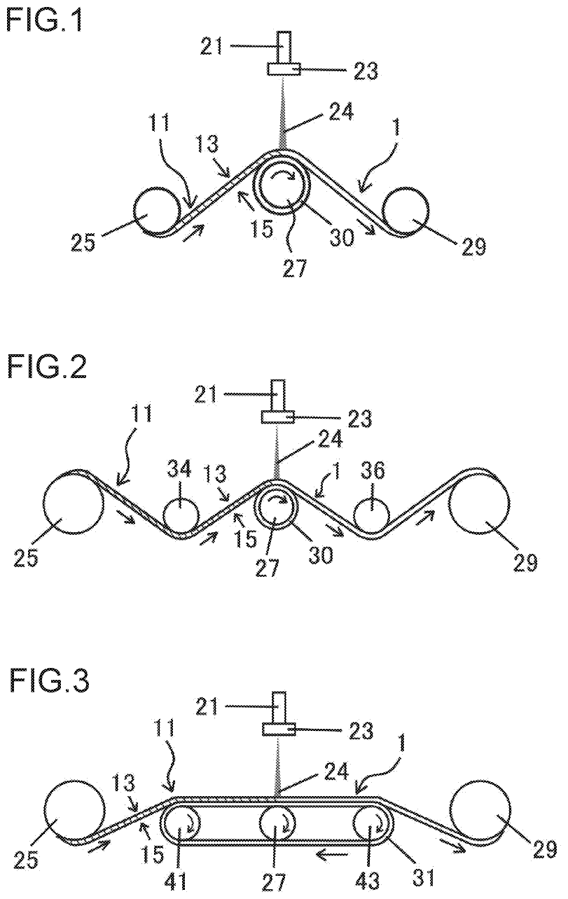

This disclosure provides a method for producing a secondary battery electrode material sheet 1 shown in FIG. 5 as a preferred example by using a roll-to-roll method, and as shown in FIG. 1, is a method for producing the secondary battery electrode material sheet 1 containing a carbide, a carbon fiber, and graphite by irradiating, with a laser, a composite fiber sheet 11 containing a carbon fiber, a resin fiber, and graphite, and further containing an adhesive resin as necessary to carbonize a resin component. The composite fiber sheet 11 is a long sheet having a first surface 13 and a second surface 15 opposite to the first surface 13, the composite fiber sheet 11 is supplied from a first roll 25 for unwinding, the first surface 13 of the composite fiber sheet 11 is continuously subjected to laser irradiation on a surface of a second roll 27, and thereafter the obtained long secondary battery electrode material sheet 1 is wound by a third roll 29 for winding, and a heat retaining body 30 made of a heat retaining material is interposed between the second roll 27 and the second surface 15 of the composite fiber sheet 11 subjected to the laser irradiation. The composite fiber sheet 11 in the case of containing the adhesive resin is a sheet in which the carbon fiber, the resin fiber, and the graphite are bound by the adhesive resin.

FIG. 5 is a schematic cross-sectional view of the produced secondary battery electrode material sheet 1, and the produced secondary battery electrode material sheet 1 has a structure in which a plurality of carbon fibers 2 and graphite 4 are dispersed in a carbonized portion (matrix made of a carbon material) 6 formed by carbonizing the resin component (the resin fiber or the adhesive resin) by the laser irradiation on the composite fiber sheet.

The composite fiber sheet, which is a raw material for producing the secondary battery electrode material sheet, is a long sheet that contains the carbon fiber, the resin fiber, and the graphite and that may further contain the adhesive resin as described above. A secondary battery electrode material sheet obtained using a composite fiber sheet containing no adhesive resin is suitable as a raw material for producing an electrode layer of a redox flow battery, and a secondary battery electrode material sheet obtained using a composite fiber sheet containing the adhesive resin is suitable as a raw material for producing a gas diffusion layer for forming a cathode or a gas diffusion layer for forming an anode of a fuel cell.

A thickness of the secondary battery electrode material sheet obtained by this disclosure is substantially the same as a thickness of the composite fiber sheet, and the thickness of the composite fiber sheet is preferably 80 μm to 2,000 μm, and more preferably 120 μm to 1,200 μm since the fuel cell, the redox flow battery, or the like can be produced directly using a secondary battery electrode material prepared by being cut into a predetermined size or the like.

The carbon fiber contained in the composite fiber sheet may be any of a vapor-grown carbon fiber, a carbon nanotube (single wall, double wall, multi-wall, cup-laminated type, and the like), a polyacrylonitrile (PAN)-based carbon fiber, a pitch-based carbon fiber, and a rayon-based carbon fiber. The carbon fiber contained in the composite fiber sheet may be only one kind, or may be two or more kinds.

A fiber diameter of the carbon fiber is not particularly limited, and an average fiber diameter thereof is preferably 5 μm to 15 μm, and more preferably 6 μm to 8 μm.

The carbon fiber usually has a fiber length with an upper limit of 12 mm and a lower limit of 2 mm. In addition, an average fiber length of the carbon fiber is preferably 2 mm to 9 mm, and more preferably 3 mm to 6 mm.

The resin fiber contained in the composite fiber sheet may be made of a material that can be carbonized by laser irradiation, and may contain a polylactic acid, a polyvinyl alcohol, a polyolefin, a polyurethane, a polyester, a polyamide, an acrylic resin, an acrylonitrile-based polymer, an aramid, a polyacetal, a phenol resin, a cellulose, or the like. The constituent material of the resin fiber contained in the composite fiber sheet may be only one kind, or may be two or more kinds.

The resin fiber may be any of a monofilament, a multifilament, and a fibril fiber. In the composite fiber sheet disclosed here, since constituent components are sufficiently mixed and entangled with each other to have excellent shape retainability, the resin fiber contains preferably 20 mass % or more, more preferably 50 mass % or more of the fibril fiber with respect to the entire resin fiber. The resin fiber is particularly preferably made of the fibril fiber and at least one selected from the monofilament and the multifilament. As the fibril fiber, for example, a fibril fiber referred to as an “acrylic pulp fiber” obtained by beating an acrylic fiber made of an acrylonitrile-based polymer into a pulp shape can be used.

A fiber diameter of the resin fiber is not particularly limited, and is preferably 5 μm to 20 μm, and more preferably 6 μm to 8 μm since the composite fiber sheet before the laser irradiation is excellent in mechanical strength and is efficiently carbonized by the laser irradiation.

A fiber length of the resin fiber is also not particularly limited, and is preferably 1 mm to 15 mm, and more preferably 1 mm to 10 mm since the composite fiber sheet before the laser irradiation is excellent in mechanical strength and is efficiently carbonized by the laser irradiation.

The graphite may be either natural graphite or artificial graphite. In addition, expanded graphite obtained by subjecting flake graphite, which is natural graphite, as a raw material to special processing may be used. The graphite contained in the composite fiber sheet may be only one kind, or may be two or more kinds.

A shape of the graphite is not particularly limited, and may be spherical, ellipsoidal, plate-shaped, linear, amorphous, or the like.

A size of the graphite is not particularly limited.

The graphite contained in the composite fiber sheet may be an aggregate of primary particles.

When the composite fiber sheet contains the carbon fiber, the resin fiber, and the graphite, content proportions of the carbon fiber, the resin fiber, and the graphite are preferably 20 mass % to 80 mass %, 5 mass % to 60 mass %, and 10 mass % to 70 mass %, more preferably 30 mass % to 70 mass %, 10 mass % to 40 mass %, and 15 mass % to 50 mass %, and still more preferably 40 mass % to 65 mass %, 15 mass % to 30 mass %, and 20 mass % to 40 mass %, respectively, when a total thereof is 100 mass %.

When the composite fiber sheet contains the adhesive resin, the adhesive resin is not particularly limited as long as it has adhesiveness to the carbon fiber, the resin fiber, and the graphite. The adhesive resin is preferably those can be carbonized by the laser irradiation, and may be a thermoplastic resin, a curable resin, or the like in this disclosure. Among these, a curable resin is preferred, and a thermosetting resin such as a phenol resin, a furan resin, an epoxy resin, a melamine resin, an imide resin, a urethane resin, an aramid resin, a urea resin, and an unsaturated polyester resin are particularly preferred.

When the composite fiber sheet contains the carbon fiber, the resin fiber, the graphite, and the adhesive resin, content proportions of the carbon fiber, the resin fiber, the graphite, and the adhesive resin are preferably 20 mass % to 80 mass %, 5 mass % to 60 mass %, 1 mass % to 50 mass %, and 10 mass % to 70 mass %, more preferably 25 mass % to 70 mass %, 7 mass % to 40 mass %, 1 mass % to 40 mass %, and 15 mass % to 50 mass %, and still more preferably 30 mass % to 65 mass %, 10 mass % to 30 mass %, 1 mass % to 30 mass %, and 20 mass % to 40 mass %, respectively, when a total thereof is 100 mass %.

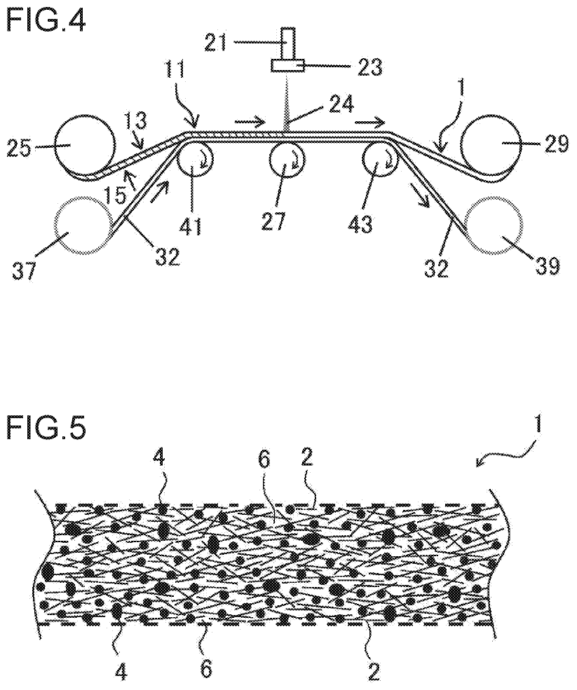

FIG. 1 shows a typical example of the method for producing the secondary battery electrode material sheet disclosed here, and shows that, when the composite fiber sheet 11 supplied from the first roll 25 reaches the second roll 27 having the heat retaining body 30 made of a heat retaining material on the surface thereof, the first surface 13 of the composite fiber sheet 11 is continuously irradiated with a laser 24 from a laser light source 21, and the resin component is carbonized in an irradiated portion of the composite fiber sheet 11, to produce the secondary battery electrode material sheet 1 in which the carbon fiber and the graphite are dispersed in the carbonized portion made of the carbide, and the secondary battery electrode material sheet 1 is wound by the third roll 29. In this manner, by performing the laser irradiation on the first surface 13 of the composite fiber sheet 11 in a state where the composite fiber sheet 11 is in contact with the heat retaining body 30 on the second roll 27, it is possible to efficiently produce the secondary battery electrode material sheet 1 with less power consumption. This disclosure in which the heat retaining material is used is not limited to the aspect in FIG. 1, and various aspects such as a heat retaining conveyor belt 31 shown in FIG. 3 and a heat retaining sheet 32 shown in FIG. 4 can be used.

The heat retaining material constituting the heat retaining body is not particularly limited as long as it does not adhere to the carbide formed when the composite fiber sheet 11 is irradiated with the laser and is stable at a temperature (about 2,000° C.) during the carbide formation. Examples thereof include carbon (graphite, a carbon fiber, a carbon composite material, and the like), a metal or an alloy having a high melting point, ceramics, and a ceramic matrix composite material. Since a structure of the composite fiber sheet 11 has voids between the plurality of fibers contained therein or between the fiber and the graphite, energy of the emitted laser may not sufficiently spread over the entire composite fiber sheet 11. Therefore, when the composite fiber sheet 11 continuously supplied from the first roll 25 continues to generate heat by absorbing the energy of the laser by the laser irradiation, a temperature of the heat retaining body 30 rotating together with the second roll 27 also increases, and a preheating effect for the subsequent composite fiber sheet 11 immediately before carbonization and a carbonization promoting effect by the laser irradiation are expected, so that the heat retaining body preferably contains graphite as a laser absorbing material.

In this disclosure, either a continuous-wave laser or a pulse-wave laser may be used as the laser with which the composite fiber sheet 11 is irradiated. In this disclosure, a continuous-wave laser is preferably used, and a semiconductor laser, a YVO₄ laser, a YLF laser, a YAG laser, a glass laser, a ruby laser, a fiber laser, an excimer laser, a carbon dioxide gas laser, an ultraviolet laser, a He-Ne laser, or the like can be used. Among these, a semiconductor laser is particularly preferred.

A laser irradiation method for the composite fiber sheet 11 is not particularly limited. This disclosure provides the method for producing the secondary battery electrode material sheet by using the roll-to-roll method, and as shown in FIG. 1, the long composite fiber sheet 11 is supplied from the first roll 25, and the first surface 13 on the heat retaining body 30 is irradiated with the laser 24 while the composite fiber sheet 11 moves. As the laser irradiation method at this time, a method of repeating spot irradiation on the first surface 13 using a plurality of laser light sources as necessary, a method of irradiating the first surface 13 with a laser while performing scanning with the laser or widening an irradiation area through a diffusion lens, or the like can be used. An incident angle of the laser with respect to the first surface 13 of the composite fiber sheet 11 is not particularly limited.

Preferred laser irradiation conditions are as follows.

An energy density during the laser irradiation is preferably 0.5 W/mm² to 5.0 W/mm², more preferably 1.0 W/mm² to 4.5 W/mm², and still more preferably 1.4 W/mm² to 4.0 W/mm² since the carbonization promoting effect for the resin component by the heat retaining body can be obtained. The energy density can be calculated based on a laser output (W) and a laser irradiation area (mm²).

The laser irradiation is preferably performed in an inert gas atmosphere in which inclusion of air and an oxygen gas is prevented as much as possible or under a vacuum condition, and particularly preferably performed in an inert gas atmosphere. Examples of an inert gas include a nitrogen gas, an argon gas, and a helium gas. For the laser irradiation under such conditions, an apparatus in a sealed environment is usually used.

A laser irradiation time for a same position in the composite fiber sheet is appropriately set according to the thickness of the composite fiber sheet, and is preferably 0.3 seconds to 30 seconds, more preferably 0.5 seconds to 20 seconds, and still more preferably 0.8 seconds to 10 seconds.

A surface layer material of the first roll 25 around which the composite fiber sheet 11 is wound and a surface layer material of the third roll 29 around which the secondary battery electrode material sheet 1 is wound are not particularly limited, and can be carbon, a metal, an alloy, ceramics, or the like. A surface layer material of the second roll 27 with which the heat retaining body 30 comes into contact is not particularly limited, and can be carbon, a metal, an alloy, ceramics, or the like, and in order to improve an effect of the heat retaining body 30, the laser absorbing material is preferably contained, and graphite is particularly preferably contained.

In the method for producing the secondary battery electrode material sheet disclosed here by using the roll-to-roll method, a feeding rate of the composite fiber sheet 11 supplied from the first roll 25 is not particularly limited, and is preferably 0.2 m/min to 10 m/min.

FIG. 2 shows a production method obtained by improving the production method in FIG. 1, and includes the first roll 25 that unwinds the composite fiber sheet 11, the second roll 27 on which the first surface 13 is subjected to the laser irradiation immediately after the second surface 15 of the composite fiber sheet 11 comes into contact therewith, and the third roll 29 that winds the produced secondary battery electrode material sheet 1, and further includes a first dancer roll 34 for stably conveying the composite fiber sheet 11 to the second roll 27 between the first roll 25 and the second roll 27, and a second dancer roll 36 for stably conveying the secondary battery electrode material sheet 1 to the third roll 29 between the second roll 27 and the third roll 29. The heat retaining body 30 is wound around the surface of the second roll 27, and a configuration and effect thereof are as described above in FIG. 1. The first dancer roll 34 and the second dancer roll 36 can be driven rolls whose axial centers are movable up and down or left and right. An angle (hereinafter, referred to as a “holding angle”) formed by a virtual straight line connecting a contact start point of the composite fiber sheet 11 with the second roll 27 and the axial center and a virtual straight line connecting a contact end point of the secondary battery electrode material sheet 1 after the laser irradiation and the axial center is appropriately selected, a tension of the composite fiber sheet 11 to the second roll 27 and a tension of the second roll 27 to the secondary battery electrode material sheet 1 are applied and adjusted, and it is possible to prevent an occurrence of distortion due to contraction or the like of the obtained secondary battery electrode material sheet 1. The holding angle is preferably 5 degrees to 40 degrees, and the tension is preferably 80 N/m or more.

FIGS. 1 and 2 show the aspect in which the heat retaining body 30 is wound around the surface of the second roll 27, and FIG. 3 shows a production method in which the composite fiber sheet 11 and the secondary battery electrode material sheet 1 are conveyed by circulation of the heat retaining conveyor belt 31 made of a heat retaining material, and a contact portion of the heat retaining conveyor belt 31 in contact with the second roll 27 and the first surface 13 of the composite fiber sheet 11 in contact with the contact portion are subjected to the laser irradiation. In the production method in FIG. 3 using the heat retaining conveyor belt 31, the heat retaining conveyor belt 31 circulates around a first conveyance roll 41 provided between the first roll 25 and the second roll 27, the second roll 27, and a second conveyance roll 43 provided between the second roll 27 and the third roll 29 and rotates together with the second roll 27 similarly to the heat retaining body 30 in FIGS. 1 and 2, a temperature of the heat retaining conveyor belt 31 is also increased by continuously absorbing the energy of the laser by the laser irradiation and generating heat in the continuously supplied composite fiber sheet 11, and the preheating effect for the subsequent composite fiber sheet 11 immediately before carbonization and the carbonization promoting effect by the laser irradiation are also expected.

FIG. 4 shows a production method in which the composite fiber sheet 11 and the secondary battery electrode material sheet 1 are conveyed by the heat retaining sheet 32 made of a heat retaining material before the laser irradiation, and a contact portion of the heat retaining sheet 32 in contact with the second roll 27 and the first surface 13 of the composite fiber sheet 11 in contact with the contact portion are subjected to the laser irradiation. The heat retaining sheet 32 is unwound from a separately prepared heat retaining sheet unwinding roll 37, and is directed to the second roll 27 while the composite fiber sheet 11 is placed thereon using the first conveyance roll 41. Thereafter, the heat retaining sheet 32 is conveyed while the secondary battery electrode material sheet 1 produced by performing laser irradiation on the composite fiber sheet 11 is placed thereon using the second conveyance roll 43, is separated in the middle, is then wound by a heat retaining sheet winding roll 39, and can be reused. On the other hand, the separated secondary battery electrode material sheet 1 is wound by the third roll 29.

As described above, in this disclosure, the laser irradiation is preferably performed in an inert gas atmosphere, and when the laser irradiation is performed on the composite fiber sheet 11, the carbon fiber or the graphite in the laser irradiated portion absorbs the energy of the laser to generate heat, and the resin component other than the carbon fiber and the graphite are instantly carbonized at a high temperature, while a decomposition gas of a resin is generated. When the laser irradiation is performed in a sealed environment and the decomposition gas stays between the laser light source 21 and the composite fiber sheet 11 as an irradiation target, stable irradiation may be difficult to be performed with the laser 24 having a predetermined energy density. In addition, when a lens 23 is used in the above manner, a surface of the lens 23 may be contaminated. Therefore, in the case of using production apparatuses having the configurations in FIGS. 1 to 4 and performing the laser irradiation in the inert gas atmosphere, it is preferable to include not only a unit for introducing the inert gas but also for discharging the decomposition gas of the resin in order to create the inert gas atmosphere inside the apparatus.

In this disclosure, for example, depending on the shape, the size, or the like of the composite fiber sheet, other steps can be further provided before and after the laser irradiation on the composite fiber sheet. For example, the composite fiber sheet can be preheated to 250° C. to 1,300° C. before the laser irradiation. In addition, after the laser irradiation, a surface of the obtained secondary battery electrode material sheet can be smoothed, or the surface of the secondary battery electrode material sheet can be subjected to a water repellent treatment.

In the case of performing preheating, known units for heating an article in the related art can be applied. Examples of the heating unit include an electric furnace, an infrared ray, a microwave, and a laser. When a preheating temperature is 300° C. to 500° C., a system atmosphere is not particularly limited, and the preheating may be performed in an air atmosphere. When the preheating temperature is higher than 500° C., the system atmosphere is preferably an inert gas atmosphere in order to prevent oxidation of the composite fiber sheet or combustion. When the composite fiber sheet is preheated at a temperature of lower than 1,300° C., the carbonization is incomplete, but an amount of the decomposition gas generated in the subsequent laser irradiation step can be reduced.

Here, a method for preparing the composite fiber sheet, which is the raw material for producing the secondary battery electrode material sheet, will be described. The composite fiber sheet containing the carbon fiber, the resin fiber, and the graphite can be prepared by subjecting a slurry containing the carbon fiber, the resin fiber, the graphite, and water to papermaking, and then squeezing and drying an obtained water-containing sheet. In addition, the composite fiber sheet containing the carbon fiber, the resin fiber, the graphite, and the adhesive resin can be prepared by bringing an obtained fiber accumulation sheet into contact with a liquid containing the adhesive resin (adhesive resin-containing liquid) after squeezing and drying the water-containing sheet described above, and drying an obtained resin impregnation sheet. In the case of obtaining the resin impregnation sheet, the fiber accumulation sheet may be brought into contact with the adhesive resin-containing liquid such that an amount of the adhesive resin added to the fiber accumulation sheet is, for example, 20 mass % to 40 mass %.

For example, when the secondary battery electrode material sheet obtained by this disclosure is used for producing a fuel cell, the secondary battery electrode material sheet can be used as a material for forming a cathode gas diffusion layer or an anode gas diffusion layer in a membrane electrode assembly having a known structure in the related art, that is, sequentially including a cathode gas diffusion layer, a microporous layer, a catalyst layer, an electrolyte layer, a catalyst layer, a microporous layer, and an anode gas diffusion layer.

### EXAMPLES

Hereinafter, this disclosure will be specifically described with reference to Examples, but this disclosure is not limited to such Examples as long as the gist disclosed here is not exceeded.

### 1. Raw Material for Producing Secondary Battery Electrode Material Sheet

### 1-1. Carbon Fiber

A carbon fiber (fiber length: 3 mm, fiber diameter: 7 μm) manufactured by Teijin Limited was used.

### 1-2. Resin Fiber

(1) Resin fiber F1

An acrylic pulp fiber (fibril fiber made of acrylonitrile-based polymer, fiber length: 2 mm) manufactured by Toyobo Co., Ltd. was used.

(2) Resin fiber F2

A vinylon fiber (made of polyvinyl alcohol, fiber length: 3 mm, fiber diameter: 11 μm) manufactured by Kuraray Co., Ltd. was used.

### 1-3. Graphite Powder

A graphite powder (average particle diameter: 50 μm) manufactured by Nippon Graphite Industries, Co., Ltd. was used.

### 2. Preparation of Composite Fiber Sheet

A composite fiber sheet (hereinafter, referred to as “composite fiber sheet S1”) used in the production of the secondary battery electrode material sheet is a long material (width: 180 mm, thickness: 200 μm) obtained by preparing the carbon fiber, the resin fiber F1, the resin fiber F2, and the graphite powder in proportions of 46 mass %, 17 mass %, 18 mass %, and 19 mass % (100 mass % in total), respectively, mixing these with water in a pulper, subjecting the obtained slurry to papermaking, followed by squeezing and drying, impregnating the obtained fiber accumulation sheet with a phenol resin solution, heating (120° C.) and drying the obtained resin impregnation sheet to volatilize the solvent, and heat-pressing (250° C., 1 minute) an obtained fiber binding sheet (amount of the phenol resin adhering is 35 parts by mass with respect to 100 parts by mass of the fiber accumulation sheet) by using a double belt press. The composite fiber sheet S1 was set on a first roll for unwinding.

### 3. Production of Secondary Battery Electrode Material Sheet

In a chamber (not shown), the composite fiber sheet S1 was irradiated with a semiconductor laser having a wavelength of 1080 nm (irradiation time: 1 second), and a decomposition gas generated by the laser irradiation on the composite fiber sheet S1 was discharged out of the chamber, thereby producing a secondary battery electrode material sheet in which the graphite powder was contained and the carbon fiber and the graphite powder were dispersed in a matrix made of a carbide of the resin component. In Examples 1 to 5, a production apparatus having a roll configuration shown in FIGS. 2, 3, or 4 was used in the chamber (not shown).

### Comparative Example 1

The composite fiber sheet S1 was processed into a predetermined size, and the surface (irradiation area: 4.4 mm×200 mm) of the sheet was subjected to the laser irradiation to efficiently carbonize the resin component, thereby obtaining a secondary battery electrode material sheet. The energy density of the laser at this time was 11.53 W/mm².

### Example 1

FIG. 2 shows a roll configuration including the first roll (25) around which the composite fiber sheet S1 (11) before the laser irradiation is wound, the second roll (27) having a layer made of graphite on the surface and having the surface further covered with one composite fiber sheet S1 (hereinafter, referred to as a “heat retaining layer T1”) as the heat retaining body 30, and the third roll (29) around which the obtained secondary battery electrode material sheet (1) is wound, and further including the first dancer roll (34) that adjusts the tension of the composite fiber sheet S1 (11) between the first roll (25) and the second roll (27), and the second dancer roll (36) that adjusts the tension to the produced secondary battery electrode material sheet (1) between the second roll (27) and the third roll (29).

In this example, the composite fiber sheet S1 (11) was supplied from the first roll (25) toward the second roll (27) at a sheet feeding speed of 0.264 m/min, and then the surface (irradiation area: 4.4 mm×200 mm) of the composite fiber sheet S1 (11) that reached the surface of the second roll (27) and that was in contact with the heat retaining layer T1 was irradiated with a laser having an energy density of 7.58 W/mm² to efficiently carbonize the resin component, thereby obtaining the secondary battery electrode material sheet (1).

In Example 1, the amount of the energy used was 65.7% with respect to the energy density (11.53 W/mm²) of the laser emitted in Comparative Example 1, and an energy reduction rate was 34.3%.

### Example 2

A secondary battery electrode material sheet was obtained by performing the same operation as in Example 1 except that the second roll (27) having the layer made of graphite on the surface and having the surface further covered with a laminated sheet (hereinafter, referred to as a “heat retaining layer T2”) made of five composite fiber sheets S1 was used instead of the second roll (27) including the heat retaining layer T 1, and the energy density of the laser was set to 6.06 W/mm². The energy reduction rate was 47.4%.

### Example 3

A secondary battery electrode material sheet was obtained by performing the same operation as in Example 1 except that the second roll (27) having the layer made of graphite on the surface and having the surface further covered with one piece of graphite felt (thickness: 2.8 mm) was used instead of the second roll (27) including the heat retaining layer T1, and the energy density of the laser was set to 5.97 W/mm². The energy reduction rate was 48.2%.

### Example 4

FIG. 3 shows a roll configuration including the first roll (25) around which the composite fiber sheet S1 (11) before the laser irradiation is wound, the second roll (27) having a layer made of graphite on the surface thereof, and the third roll (29) that winds the obtained secondary battery electrode material sheet (1), and further including the first conveyance roll (41) between the first roll (25) and the second roll (27), the second conveyance roll (43) between the second roll (27) and the third roll (29), and the heat retaining conveyor belt (31) made of the laminated sheet (heat retaining layer T2) and circulating around the first conveyance roll (41), the second roll (27), and the second conveyance roll (43).

In this example, the composite fiber sheet S1 (11) was supplied from the first roll (25) toward the second roll (27) at a sheet feeding speed of 0.264 m/min using the heat retaining conveyor belt (31), and then the first surface (irradiation area: 4.4 mm×200 mm) of the composite fiber sheet S1 (11) that reached the surface of the second roll (27) and that was in contact with the heat retaining layer T2 was irradiated with a laser having an energy density of 6.25 W/mm² to efficiently carbonize the resin component, thereby obtaining the secondary battery electrode material sheet (1). The energy reduction rate was 45.8%.

### Example 5

A secondary battery electrode material sheet was obtained by performing the same operation as in Example 4 except that a material of the heat retaining conveyor belt (31) was one piece of graphite felt (thickness: 2.8 mm) instead of the laminated sheet (heat retaining layer T2) and the energy density of the laser was set to 6.12 W/mm². The energy reduction rate was 46.9%.

### Example 6

FIG. 4 shows a roll configuration including the first roll (25) around which the composite fiber sheet S1 (11) before the laser irradiation is wound, the second roll (27) having a layer made of graphite on the surface thereof, and the third roll (29) that winds the obtained secondary battery electrode material sheet (1), and further including the first conveyance roll (41) between the first roll (25) and the second roll (27), the second conveyance roll (43) between the second roll (27) and the third roll (29), and the heat retaining sheet unwinding roll (37) and the heat retaining sheet winding roll (39) for supplying and collecting (winding) the heat retaining sheet (32) made of the laminated sheet (heat retaining layer T2) using the first conveyance roll (41), the second roll (27), and the second conveyance roll (43).

In this example, the composite fiber sheets S1 (11) and the heat retaining sheet (32) were fed from the first roll (25) toward the second roll (27) at the same sheet feeding speed (0.264 m/min), and then the surface (irradiation area: 4.4 mm×200 mm) of the composite fiber sheets S1 (11) that reached the surface of the second roll (27) and that was in contact with the laminated sheet (heat retaining layer T2) was irradiated with a laser having an energy density of 6.22 W/mm² to efficiently carbonize the resin component, thereby obtaining the secondary battery electrode material sheet (1). The energy reduction rate was 46.1%.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

This disclosure is described below.
[1] A method for producing a secondary battery electrode material sheet, the method including:
irradiating a composite fiber sheet containing a carbon fiber, a resin fiber, and graphite with a laser to carbonize the resin fiber to obtain a secondary battery electrode material sheet containing a carbide, the carbon fiber, and the graphite, in which
the composite fiber sheet is a long sheet having a first surface and a second surface opposite to the first surface,
the composite fiber sheet is supplied from a first roll for unwinding, the first surface of the composite fiber sheet is continuously subjected to laser irradiation on a surface of a second roll, and thereafter the obtained long secondary battery electrode material sheet is wound by a third roll for winding, and
a heat retaining body is interposed between the second surface of the composite fiber sheet subjected to the laser irradiation and the surface of the second roll.
[2] The method for producing a secondary battery electrode material sheet according to the above [1], in which the composite fiber sheet contains an adhesive resin that binds the carbon fiber, the resin fiber, and the graphite, and the adhesive resin is also carbonized by the laser irradiation.
[3] The method for producing a secondary battery electrode material sheet according to the above [1], in which a layer containing a laser absorbing material is provided on the surface of the second roll.
[4] The method for producing a secondary battery electrode material sheet according to the above [1], in which the laser irradiation is performed in an inert gas atmosphere.
[5] The method for producing a secondary battery electrode material sheet according to the above [1], in which the composite fiber sheet is subjected to the laser irradiation while discharging a decomposition gas of a resin.
[6] The method for producing a secondary battery electrode material sheet according to the above [1], in which the composite fiber sheet is preheated to 250° C. to 1,300° C. before the laser irradiation
[7] A secondary battery electrode material sheet obtained by the method for producing a secondary battery electrode material sheet of the above [1].

According to this disclosure, a composite fiber sheet containing a carbon fiber, a resin fiber, and graphite, or a composite fiber sheet in which a carbon fiber, a resin fiber, and graphite are bound to an adhesive resin can be continuously irradiated with a laser to efficiently carbonize a resin component (the resin fiber or the adhesive resin), and a secondary battery electrode material sheet can be efficiently produced with less power consumption.

### INDUSTRIAL APPLICABILITY

The secondary battery electrode material sheet obtained by this disclosure can be used, for example, as a raw material for producing a gas diffusion layer for forming a cathode or a gas diffusion layer for forming an anode of a fuel cell, or as a raw material for producing an electrode layer of a redox flow battery, after being processed into an electrode material for a secondary battery of a predetermined size by cutting or the like.

What is claimed is:

1. A method for producing a secondary battery electrode material sheet, the method comprising:
irradiating a composite fiber sheet containing a carbon fiber, a resin fiber, and graphite with a laser to carbonize the resin fiber to obtain a secondary battery electrode material sheet containing a carbide, the carbon fiber, and the graphite, wherein
the composite fiber sheet is a long sheet having a first surface and a second surface opposite to the first surface,
the composite fiber sheet is supplied from a first roll for unwinding, the first surface of the composite fiber sheet is continuously subjected to laser irradiation on a surface of a second roll, and thereafter the obtained long secondary battery electrode material sheet is wound by a third roll for winding, and
a heat retaining body is interposed between the second surface of the composite fiber sheet subjected to the laser irradiation and the surface of the second roll.

2. The method for producing a secondary battery electrode material sheet according to claim 1, wherein
the composite fiber sheet contains an adhesive resin that binds the carbon fiber, the resin fiber, and the graphite, and the adhesive resin is also carbonized by the laser irradiation.

3. The method for producing a secondary battery electrode material sheet according to claim 1, wherein
a layer containing a laser absorbing material is provided on the surface of the second roll.

4. The method for producing a secondary battery electrode material sheet according to claim 1, wherein
the laser irradiation is performed in an inert gas atmosphere.

5. The method for producing a secondary battery electrode material sheet according to claim 1, wherein
the composite fiber sheet is subjected to the laser irradiation while discharging a decomposition gas of a resin.

6. The method for producing a secondary battery electrode material sheet according to claim 1, wherein
the composite fiber sheet is preheated to 250° C. to 1,300° C. before the laser irradiation.

7. A secondary battery electrode material sheet obtained by the method for producing a secondary battery electrode material sheet of claim 1.
